(19) United States
(12) Patent Application Publication
(10) Pub. No.: US 2003/0027604 A1
(43) Pub. Date: Feb. 6, 2003

(54) Mobile communication terminal device capable of changing output sound and output sound control method

(75) Inventor: Keiichi Hayashi, Kanagawa (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/200,484

(22) Filed: Jul. 23, 2002

(30) Foreign Application Priority Data
Aug. 1, 2001 (JP) 233649/2001

(51) Int. Cl. H04M 1/00

(52) U.S. Cl. 455/567; 455/414

(57) ABSTRACT

A mobile communication terminal device capable of communication with a Web server on a network comprising a controller for obtaining tone information or a tone information set used for a call arrival ringer sounds, key identification sounds or game sounds from a Web server. The controller stores the tone information in a tone data table in memory. The controller sets the tone information and the sound generation duration in a tone generator. The tone generator generates sound with a tone conforming to the set tone information during the sound generation through a speaker.

### BACKGROUND OF THE INVENTION

1. Field of the Invention

The present invention relates to a mobile communication terminal device and output sound control method for the mobile communication terminal device. In particular, the present invention relates to a mobile communication terminal device and a output sound control method for the mobile communication terminal device that allows tone changes in selected sounds (e.g., a call arrival ringer sound) and a key identification sound based on tone information obtained from a computer connected to a network.

2. Description of the Related Art

In a conventional mobile phone, sounds, such as a ringer sound on an incoming call, a key identification sound for identifying a key on a key press on the mobile phones, or a sound during a game is produced on the mobile phones, are be generated using only a fixed set of tones programmed in the mobile phone.

An example of related art directed to ringer sounds of mobile phones is proposed in Japanese Laid-Open Patent Application 2001-100769. The specification discloses a mobile terminal device comprising a memory means for storing playback information and lyrics information corresponding to progress of playback, a sound generation control means for generating musical sound signals in sequence based on the stored playback information, and a display means for generating lyrics display signals corresponding to the generated music sound signals based on the stored lyrics information.

Another example of related art directed to ringer sounds of mobile phones was proposed in Japanese Laid-Open Patent Application Heisei 11103332. The specification discloses a mobile communication terminal, characterized in that any melody created by a user is stored and the melody is reproduced as a ringer sound signaling an incoming call.

As described above, however, in conventional mobile phones, sounds can be generated using only a fixed set of tones programmed in the mobile phones (e.g., a ringer sound on an incoming call, a key identification sound on a key press, or sound effects in a game). Therefore, the tones cannot be changed for each function of the mobile phone, e.g., generating a sound for an incoming call, or for generating sound effects during the performance of a game on the mobile phone. Some types of mobile phones allow key identification sounds and tones to be programmed. However, usable sounds and tones are limited to a fixed range of tone information sets in the mobile phones and different tones cannot be used for each function or usage scene without restraint.

### SUMMARY OF THE INVENTION

An aspect of the present invention is to provide a mobile communication terminal device and a output sound control method for the mobile communication terminal device that allows a sound to be generated by using a tone appropriate for each function of the mobile communication terminal device or each usage scene of the mobile communication terminal device at the time of generating the sound for an incoming call arrival, a key press, or during the performance of a game.

To solve the above mentioned problem, a mobile communication terminal device of the present invention comprises a communicating means for communicating with a device coupled to a network, an obtaining means for obtaining tone information from the device and an outputting means for outputting sound corresponding to the tone information. The sound is at least one of a call arrival ringer sound or a key identification sound identifying a key when the key is pressed. The mobile communication terminal device further comprises a storing means that stores the tone information and a setting means for setting a time duration for the sound output. The outputting means outputs the sound for that set time. The storing means can also store a tone number used for distinguishing the tone information, as well as a bank number assigned to a usage scene of the mobile communication terminal device. The mobile communication device is preferably a mobile phone and the device is preferably a Web server. The obtaining means can obtain the tone information attached to an electronic mail message. The sound is a ringer sound that indicates at least one of the arrival of the electronic mail message and the opening of the electronic mail message.

Further, a mobile communication terminal device of the present invention comprises a communicating circuit that communicates with a device provided on a network, an obtaining circuit that obtains tone information from the device and an outputting circuit that outputs sound corresponding to the tone information. The generated sound is at least one of a call arrival ringer sound and a key identification sound identifying a key when the key is pressed. The mobile communication terminal device further comprises a memory that stores the tone information and a setting circuit that sets a time duration for the sound generation. The outputting circuit outputs the sound for that set time. The memory can also store a tone number used for distinguishing the tone information, as well as a bank number assigned to a usage scene of the mobile communication terminal device. Preferably, the mobile communication device is a mobile phone and the device is a Web server. The obtaining circuit can obtain the tone information attached to an electronic mail message. The sound is a ringer sound indicates at least one of the arrival of the electronic mail message and the opening of the electronic mail message.

An output sound control method for a mobile communication device comprises the detection of a predetermined operation by an user, obtaining tone information from a device coupled to a network, storing the tone information and outputting sounds that correspond to the tone information. The sounds are at least one of a call arrival ringer sound and a key identification sound that identifies a key when the key is pressed. Preferably, the mobile communication device is a mobile phone and the device is a Web server. The output sound control method further comprises receiving an electronic mail message attached the tone information and outputting a ringer sound corresponding to the tone information, indicating at least one of the arrival of the electronic mail message and the opening of the electronic mail message.

According to the present invention, in the mobile communication terminal device, tone information used for a call arrival ringer sound and a key identification sound used for identifying a depressed key is obtained from a tone information providing device. The tone information is stored in the tone data table. The tone information and a sound generation duration is set in the tone generator, and control is performed for generating the sound with a tone conforming to the tone information during a tone generation duration set in the tone generator. Therefore, when a sound is generated on arrival of a call, on a key press, or during a game on a mobile communication terminal device, the user can cause the sound to be generated with a tone adapted to each function or usage scene of the mobile communication terminal device. Further, the user can cause a wide variety of tones to be generated on the mobile communication terminal device by obtaining tone information from a tone information providing device to change tone information in the tone data table in the mobile communication terminal device. Furthermore, the user can cause a tone specialized to any given function of the mobile communication terminal device to be generated. This is done by allocating, in the tone data table, a tone number used for identifying a tone and a bank number assigned to a usage scene of the mobile communication terminal device as appropriate and changing the arrangement of the tone data table. The user can change and cause a tone to be generated on the mobile communication terminal device to be generated without changing software contained in the mobile communication terminal device or data about a tone that is stored in memory of the mobile communication terminal device. This is because information in the tone data table can be updated dynamically by obtaining tone information from the tone information providing device to change tone information in the tone data table of the mobile communication terminal device.

### BRIEF DESCRIPTION OF THE DRAWINGS

These and other aspects, features and advantages of the invention will become more fully apparent from the following detailed description taken in conjunction with accompanying drawings. In the drawings:

FIG. 1 is a conceptual diagram showing an exemplary configuration of a communication system according to an embodiment of the present invention;

FIG. 2 is a block diagram showing an exemplary configuration of a mobile terminal according to an embodiment of the present invention;

FIG. 3 is an illustrative diagram showing an exemplary configuration of a tone data table of the mobile terminal according to an embodiment of the present invention;

FIG. 4 is a flowchart showing a process for registering downloaded data in the tone data table of the mobile terminal according to an embodiment of the present invention; and

FIG. 5 is a flowchart showing a process for generating an identification sound when a key of the mobile terminal is pressed according to an embodiment of the present invention.

### DETAILED DESCRIPTION OF THE EMBODIMENTS

Hereinafter, each embodiment of the present invention will be described in detail with reference to the drawings.

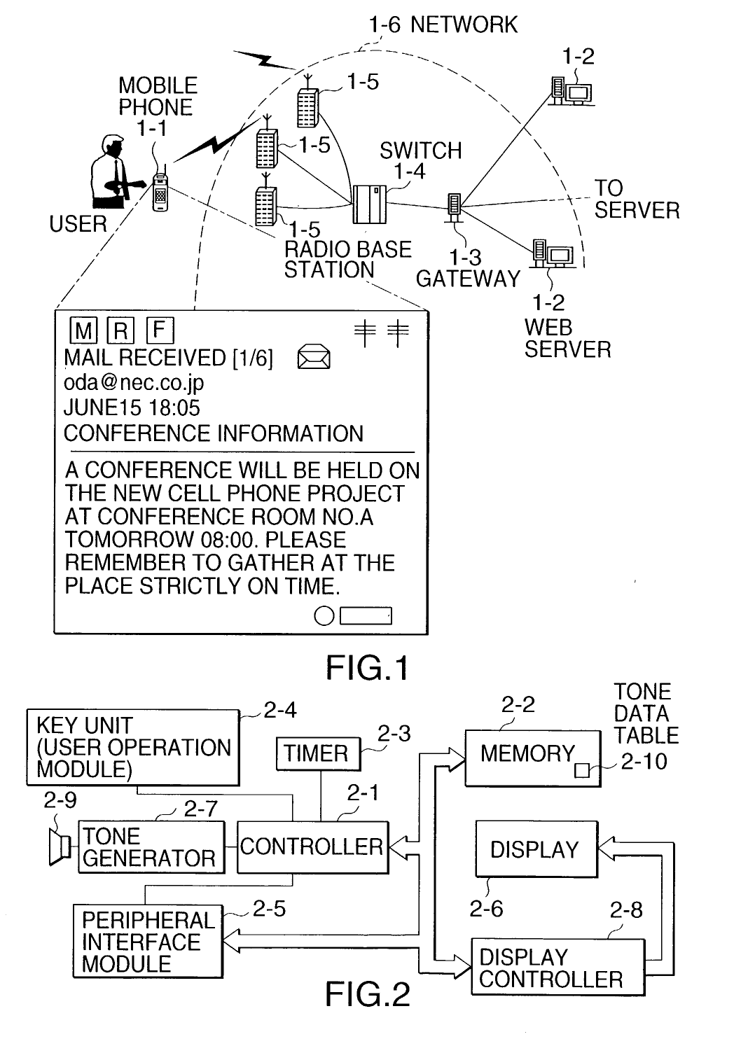

FIG. 1 is a diagram showing an exemplary configuration of a communication system according to an embodiment of the present invention. The communication system comprises a mobile terminal 1-1, a plurality of Web servers 1-2, a gateway 1-3, and a switch 1-4, a plurality of radio base stations 1-5, and a network 1-6.

The mobile terminal 1-1 can obtain data from a Web server 1-2 on the network 1-6, use the obtained data, and store the obtained data. The mobile terminal 1-1 has also the capability of obtaining tone information or a tone information set that is used for ringer sounds, key identification sounds, alarm sounds, and game sound effects from the Web server 1-2 on the network 1-6. The mobile terminal 1-1 sets the ringer sounds, key identification sounds, alarm sounds and game sound effects with respect to the obtained tone information or tone information set. In addition, when generating a sound for an incoming call, for pressing a key, for an alarm, or while playing a game, the mobile terminal 1-1 can generate the sound with a tone registered in the tone information or tone information set.

In particular, the plurality of Web servers 1-2 are configured as Web site servers that provide the data, e.g., a file, tone information, or a tone information set, over the network 1-6 and mail servers that perform processes for sending and receiving electronic mail over the network 1-6. In this description, they are generically referred to as Web servers. The gateway 1-3 enables access between the mobile terminal network and the network 1-6. The switch 1-4 is interposed between the plurality of radio base stations 1-5 and the gateway 1-3 and performs switching operations. The radio base stations 1-5 are interposed between the mobile terminal 1-1 and the party of communication and relay radio waves to the mobile terminal 1-1.

FIG. 2 is a block diagram showing an exemplary configuration of the mobile terminal 1-1 in an embodiment of the present invention. The mobile terminal 1-1 comprises a controller 2-1, memory 2-2, a timer 2-3, a key unit (user operation portion) 2-4, a peripheral interface module 2-5, a display 2-6, a tone generator 2-7, a display controller 2-8 and a speaker 2-9.

The controller 2-1 controls components of the mobile terminal 1-1. The memory 2-2 stores a tone data table 2-10. The timer 2-3 keeps track of time. The key unit (user operation portion) 2-4 comprises a ten-key pad for inputting information such as a telephone number, and function keys for selecting a function to be performed by the mobile terminal 1-1. The peripheral interface module 2-5 interfaces between the mobile terminal 1-1 and a peripheral device connectable to the mobile terminal 1-1. The display 2-6 displays a telephone number and a message. The tone generator 2-7 generates sounds, e.g., a ringer sound, a key identification sound, an alarm sound, or game sounds, with the tone conforming to the set tone information from the speaker 2-9. The display controller 2-8 performs display control for the display 2-6.

The mobile terminal 1-1 obtains tone information or a tone information set (tone data set) from the Web server 1-2 on the network 1-6 through the gateway 1-3, switch 1-4, and radio base station 1-5. The tone information or tone information set is stored in the tone data table 2-10 in the memory 2-2. The mobile terminal 1-1 is configured such that the user sets a tone through the key unit (user operation portion) 2-4 of the mobile terminal 1-1 in advance. A sound can be generated with the preset tone on arrival of an incoming call, a key press, an alarm, or during a game.

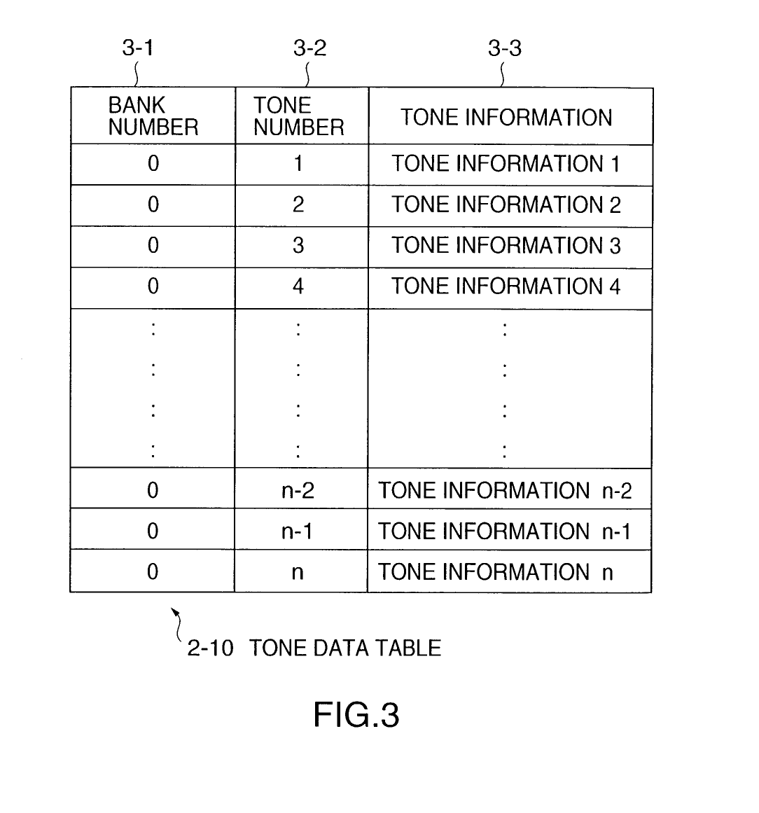

FIG. 3 is an illustrative diagram showing an exemplary configuration of the tone data table 2-10 of the mobile terminal 1-1 in an embodiment of the present invention. The tone data table 2-10 comprises bank number 3-1, tone number 3-2, and tone information 3-3 columns. The tone information 3-3 column contains tone information, e.g., musical instrument digital interface (MIDI) information used in actually generating a sound on the mobile terminal 1-1.

The numbers in the bank number 3-1 column can be assigned to a function, such as a display operation function of the mobile terminal 1-1 or a usage scene such as a game performed on the mobile terminal 1-1. The numbers in the tone numbers 3-2 column can be used for using different tones within one function of the mobile terminal 1-1. The data configuration of the tone data table 2-10 in FIG. 3 is an exemplary embodiment, and the bank number 3-1 column can be omitted if a tone data table is provided for each individual function. For functions that use sounds, only values stored in the tone number 3-2 column and duration of the sound generation duration could be required to be stored or written in a program.

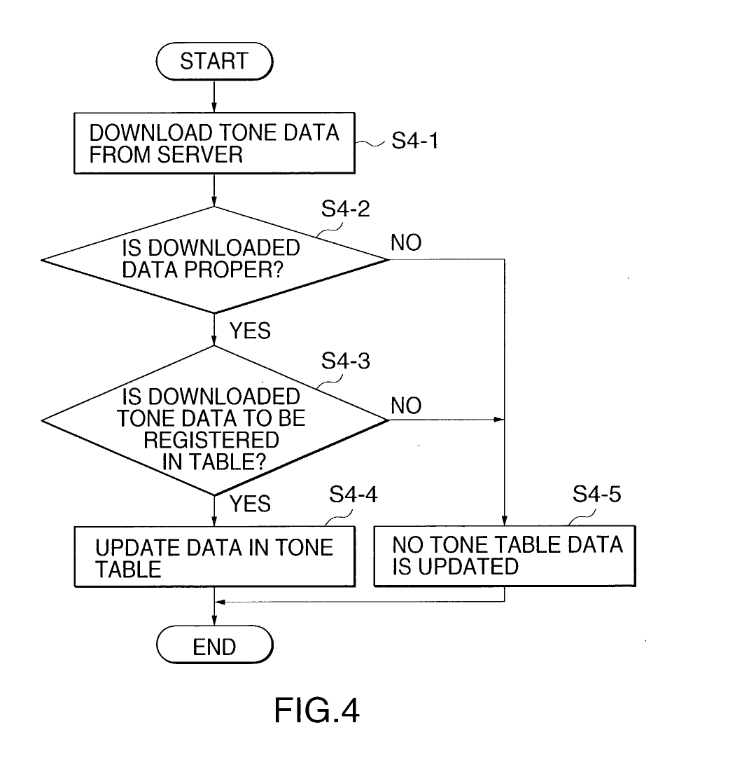

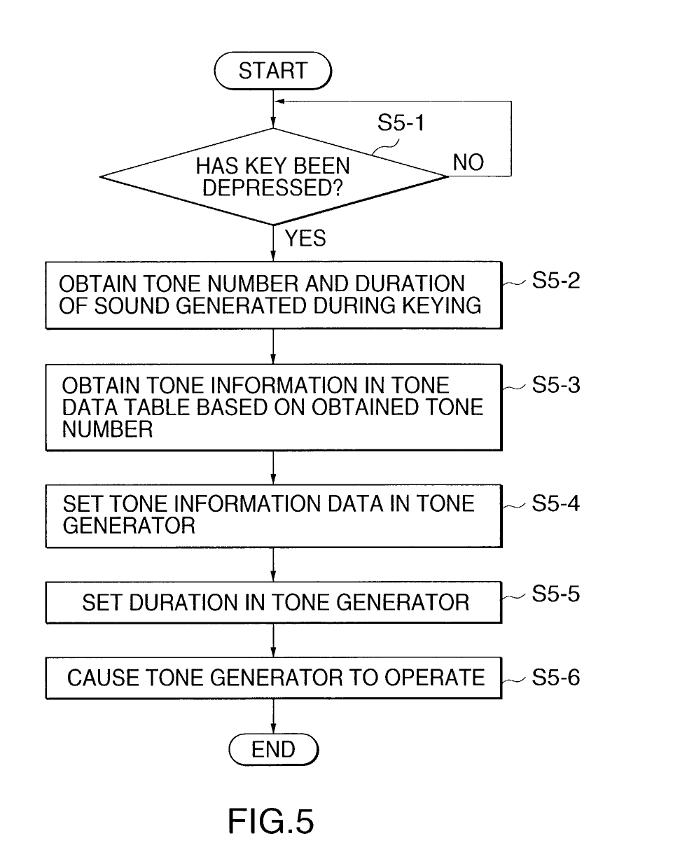

Next, the operation of an embodiment of the present invention will be described in detail below with reference to FIGS. 1 through 5. In this embodiment, an example of a process for registering downloaded data in the tone data table 2-10 and an example of a process for generating an identification sound when a key is depressed will be described with reference to flowcharts in FIGS. 4 and 5.

The process for registering downloaded data in tone data table will now be described in greater detail with reference to FIG. 4. When the user performs a predetermined operation through the key unit (user operation portion) 2-4 of the mobile terminal 1-1, the controller 2-1 downloads tone information to be stored in the tone data table 2-10 in the memory 2-2 from a Web server 1-2 (S4-1). The controller 2-1 then examines whether the tone information downloaded from the Web server 1-2 conforms to a format in the mobile terminal 1-1 (S4-2). If the examination determines that the tone information downloaded from the Web server 1-2 is proper, the controller 2-1 displays a query message on the display 2-6 through the display controller 2-8. The query message asks the user of the mobile terminal 1-1 whether he or she wants to register the tone information downloaded from the Web server 1-2 in the tone data table 2-10 in the memory 2-2 (S4-3).

If the user provides permission for the registration of the tone information through the key unit (user operation portion) 2-4, the controller 2-1 updates the tone information in the tone data table 2-10 in the memory 2-2 (S4-4). If the tone information downloaded from the Web server 1-2 contains an error, the controller 2-1 does not update the tone information in the tone data table in the memory 2-2 (step S4-5). The same result is accomplished if the he user indicates through the key unit (user operation portion) 2-4 that he or she does not register the tone information. A method of updating the tone data table for one tone or a method of updating the entire tone data table 2-10 may be used.

The key press identification sound generation process will now be described in greater detail with reference to FIG. 5. The mobile terminal 1-1 determines if the user presses a given key on the key unit (user operation portion) 2-4 with downloaded tone information being set in the tone data table 2-10 in the memory 2-2 (S5-1). The controller 2-1 obtains, from a program or from the memory 2-2, the tone number of a sound to be generated during the keying and the generation duration of the sound (S5-2). The controller 2-1 then obtains tone information having the same number as the obtained tone number from the tone data table 2-10 in the memory 2-2 (S5-3).

Then, the controller 2-1 sets the tone information obtained from the tone data table 2-10 in the memory 2-2 into the tone generator 2-7 (S5-4). The controller 2-1 next sets the generation duration in the tone generator 2-7 (S5-5). After the completion of the setting of the tone information and the generation duration, the controller 2-1 directs the tone generator 2-7 to generate the sound (S5-6). The sound is emitted from the speaker 2-9 with the tone conforming to the set tone information during the length of the sound generation.

In FIG. 5, S5-1 through S5-6 described a process for generating a sound when the key is pressed. The same procedure can be used to set tone information in the tone generator 2-7 to generate a ringer sound on arrival of an incoming call on the mobile terminal 1-1, sound effects to used when a game performed on the mobile terminal 1-1, or sounds for other functions of the mobile terminal 1-1.

As described above, according to an embodiment of the present invention, a tone data table 2-10 is provided in the memory 2-2 within the mobile terminal 1-1. Tone information for the tone data table is downloaded from a Web server 1-2 on the network 1-6 for each function or usage scene of the mobile terminal 1-1 to change tone information in the tone data table. Updated tone information in the tone data table is set in the tone generator 2-7. When a ringer sound on call arrival, a key identification sound, an alarm sound, or a game sound is generated, the sound can be generated with a tone conforming to the tone information downloaded from the Web server 1-2.

That is, when the ringer sound, the key identification sound, the alarm sound, or the game sound effects are generated, the sound can be generated with a tone conforming to tone information or an obtained tone information set. In addition, the sound can be generated with a different tone out of conventional electronic tones. Because the tone information or tone information set can be dynamically changed, sounds can be generated with a wide variety of tones for each function or each usage scene of the mobile terminal 1-1.

The present invention can be applied also to a portable electronic-mail terminal device, in which tone information or a tone information set can be downloaded from a Web server 1-2. The downloaded tone information or tone information set can be set as an identification sound on a key press or sound effects in a game.

In the portable electronic-mail terminal device, when a ringer sound data indicating the arrival of electronic mail is generated, or when a ringer sound data attached to the electronic mail is generated on opening of the electronic mail, the tone of the sound can be changed freely without changing the data that is the basis for the sound. The electronic-mail arrival ringer sound and the electronic-mail opening ringer sound can be generated with different tones for different users of the portable electronic-mail terminal device. In addition, if the portable electronic-mail terminal device has a game function, tones generated in sound effects can freely be changed without making changes to game software because the tone information can be changed on the basis of a tone data table.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A mobile communication terminal device comprising:
communicating means for communicating with a device coupled to a network;
obtaining means for obtaining tone information from said device; and
outputting means for outputting sounds that correspond to said tone information.

2. The mobile communication terminal device as claimed in claim 1, wherein said sound is at least one of a call arrival ringer sound and a key identification sound identifying a key when the key is pressed.

3. The mobile communication terminal device as claimed in claim 2, further comprising:
storing means for storing said tone information; and
setting means for setting a time duration for the sound output.

4. The mobile communication terminal device as claimed in claim 3, said outputting means outputs said sound for said time.

5. The mobile communication terminal device as claimed in claim 4, wherein said storing means stores a tone number used for distinguishing said tone information.

6. The mobile communication terminal device as claimed in claim 4, wherein said storing means stores a bank number assigned to a usage scene of said mobile communication terminal device.

7. The mobile communication terminal device as claimed in claim 5, wherein said mobile communication device is a mobile phone and said device is a Web server.

8. The mobile communication terminal device as claimed in claim 1, wherein said obtaining means obtains said tone information attached to an electronic mail message.

9. The mobile communication terminal device as claimed in claim 7, wherein said sound is a ringer sound indicating at least one of the arrival of said electronic mail message and the opening of said electronic mail message.

10. A mobile communication terminal device comprising:
a communicating circuit that communicates with a device coupled to a network;
an obtaining circuit that obtains tone information from said device; and
an outputting circuit that outputs sounds that correspond to said tone information.

11. The mobile communication terminal device as claimed in claim 10, wherein said sound is at least one of a call arrival ringer sound and a key identification sound identifying a key when the key is pressed.

12. The mobile communication terminal device as claimed in claim 11, further comprising:
a memory that stores said tone information; and
a setting circuit that sets a time duration for the sound output.

13. The mobile communication terminal device as claimed in claim 12, said outputting circuit outputs said sound for said time.

14. The mobile communication terminal device as claimed in claim 13, said memory stores a tone number used for distinguishing said tone information.

15. The mobile communication terminal device as claimed in claim 13, said memory stores a bank number assigned to a usage scene of said mobile communication terminal device.

16. The mobile communication terminal device as claimed in claim 14, said mobile communication device is a mobile phone and said device is a Web server.

17. The mobile communication terminal device as claimed in claim 10, wherein said obtaining circuit obtains said tone information attached to an electronic mail message.

18. The mobile communication terminal device as claimed in claim 17, wherein said sound is a ringer sound indicating at least one of the arrival of said electronic mail message and the opening of said electronic mail message.

19. An output sound control method for a mobile communication device comprising:
detecting a predetermined operation by an user;
obtaining tone information from a device coupled to a network;
storing said tone information; and
outputting sound corresponding to said tone information.

20. The output sound control method as claimed in claim 19, wherein said sound is at least one of a call arrival ringer sound and a key identification sound identifying a key when the key is pressed.

21. The output sound control method as claimed in claim 20, wherein said mobile communication device is a mobile phone and said device is a Web server.

22. The output sound control method as claimed in claim 20, further comprising:
receiving an electronic mail message attached said tone information; and
outputting a ringer sound corresponding to said tone information indicating at least one the arrival of said electronic mail message and the opening of when said electronic mail message.

23. The output sound control method as claimed in claim 20, said storing of said tone information further comprising:
determining if said tone information has errors; and
if that determination is true, storing said tone information in a tone table; otherwise, discarding said tone information.
